(19) United States
(12) Patent Application Publication
(10) Pub. No.: US 2003/0110217 A1
(43) Pub. Date: Jun. 12, 2003

(54) Method and apparatus for a networked projection system

(76) Inventor: Narayan D. Raju, Milpitas, CA (US)

Correspondence Address: ROSENTHAL & OSHA L.L.P., 1221 MCKINNEY AVENUE, SUITE 2800, HOUSTON, TX, 77010, US

(21) Appl. No.: 10/020,017

(22) Filed: Dec. 7, 2001

(51) Int. Cl. G06F 15/16

(52) U.S. Cl. 709/204; 709/231

(57) ABSTRACT

A networked projection system having a client computer operatively connected to a projection computer including a content controller that captures and processes presentation media located on the client computer, and a network projection controller located on the projection computer that provides an interface between the content controller and a projector operatively connected to the projection computer.

### BACKGROUND OF INVENTION

A typical computer system has at least a microprocessor, a memory, a means for input, and a means for output. The microprocessor processes, i.e., executes, instructions to accomplish various tasks of the computer system. Such instructions, along with the data required by the microprocessor when executing these instructions, are stored in some form of memory. These instructions are typically input into the computer by an input device such as a keyboard, a mouse, etc. The result of the microprocessor processes are typically shown to the user via an output means such as a cathode-ray tube display, a projector, etc.

FIG. 1 shows a typical computer system (11) having a microprocessor (10), some form of memory (12), an input/output controller (also known and referred to as “I/O Controller”) (14), and a network interface (26). The microprocessor (10) has, among other components, a central processing unit (also known and referred to as “CPU” or “execution unit”) (16), and a memory controller (also known as “load/store unit”) (18). The CPU (16) is where the actual arithmetic and logical operations of the computer system take place. To facilitate the execution of operations by the CPU (16), the memory controller (18) provides the CPU (16) with necessary instructions and data from the memory (12). The memory controller (18) also stores information generated by the CPU (16) into the memory (12). Further, the memory controller (18) sends and receives data from the I/O controller (14). The I/O controller (14) receives data from the input device (20), and sends data to the output devices (22), (24). In FIG. 1, the output devices are a CRT display (22) and a projector (24). Typically, computer systems are designed to allow multiple input devices (20) and multiple output devices (22), (24). The network interface (26) allows the computer system to send and receive data from other computers connected to a network (not shown). The network interface (26) runs protocols such as Transmission Control Protocol (TCP) and Internet Protocol (IP). TCP governs the breakup of data messages into packets to be sent via IP, and then reassembly and verification of complete messages from packets received by IP. IP governs the routing of packets from the sender to destination network and station.

With wide-spread adoption of the Internet, network computing, e.g., accessing information on a computer from a remote location, has become a necessity. AT&T (American Telephone & Telegraph) developed a Virtual Network Computing (VNC) protocol to address this need. The technology underlying VNC is a simple protocol for remote access to graphical user interfaces. VNC is designed to work at a framebuffer level and, therefore, applies to all operating system platforms or any device with some form of network link. The VNC protocol operates over any reliable transport protocol, such as TCP/IP. The VNC protocol includes two portions: a server and a viewer. The VNC server loads information into the framebuffer. The graphical user interface system and applications running on the VNC server generate the information. The VNC viewer interacts with the user by outputting information on the screen, and sending information back to the VNC server. FIG. 2 illustrates a typical VNC protocol configuration where one computer containing a VNC server (28) provides information to two separate computers containing VNC viewers (30), (32) across a server (44) and multiple network connections (34), (36), (38). The computers containing VNC viewers (30), (32) output the data sent to them by the computer containing the VNC server (28) to their respective output devices (40), (42).

In addition to network computing, computer-based multimedia presentations have also become increasingly popular. This has been facilitated by the development and refinement of computer presentation software. Additionally, computer manufacturers have developed projectors that can interface with computers. These projectors are designed to physically interface with the computer containing the presentation. To be displayed on projector, a presentation must be located on a computer directly connected to the projector and be controlled by that computer e.g., using a USB, serial port, etc.

### SUMMARY OF INVENTION

In general, in one aspect, the present invention relates to a networked projection system having a client computer operatively connected to a projection computer, comprising a content controller that captures and processes presentation media located on the client computer, and a network projection controller located on the projection computer that provides an interface between the content controller and a projector operatively connected to the projection computer.

In general, in one aspect, the present invention relates to a networked projection system having a client computer operatively connected to a projection computer, comprising a content controller that captures and processes presentation media located on the client computer, a network projection controller located on the projection computer that provides an interface between the content controller and a projector operatively connected to the projection computer, a user interface located on the client computer for accessing and controlling the networked projection system, a presentation application located on the client computer for executing and displaying presentation media on a display device, and a media server located on the client computer that processes and packages presentation media to send to the network projection controller.

In general, in one aspect, the present invention relates to a method for using a networked projection system, comprising connecting to a projection server from a client computer, accessing the projection server from the client computer, determining if a content controller is located on the client computer by the projection server, loading the content controller and media servers if the content controller is not located on the client computer, initializing the content controller on the client computer by the projection server, executing a presentation using a presentation application on the client computer, capturing presentation media by the content controller, processing presentation media on the client computer by the content controller, forwarding processed presentation media from the client computer to the projection server, reconstructing presentation media by a media viewer operatively connected to the projection server, and outputting reconstructed presentation media to a projector.

In general, in one aspect, the present invention relates to an apparatus for using a networked projection system, comprising means for connecting to a projection server from a client computer, means for accessing the projection server from the client computer, means for determining if a content controller is located on the client computer by the projection server, means for loading the content controller and media servers if the content controller is not located on the client computer, means for initializing the content controller on the client computer by the projection server, means for executing a presentation using a presentation application on the client computer, means for capturing presentation media by the content controller, means for processing presentation media on the client computer by the content controller, means for forwarding processed presentation media from the client computer to the projection server, means for reconstructing presentation media by a media viewer operatively connected to the projection server, and means for outputting reconstructed presentation media to a projector.

Other aspects and advantages of the invention will be apparent from the following description and the appended claims.

### BRIEF DESCRIPTION OF DRAWINGS

FIG. 1 illustrates a typical computer system.

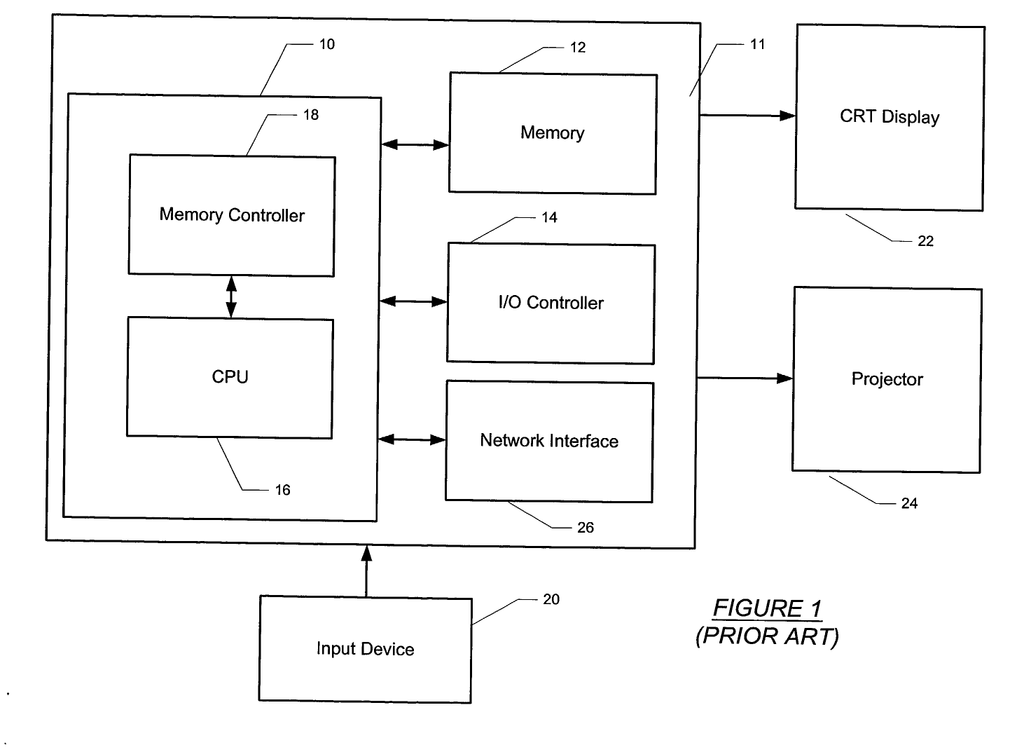

FIG. 2 illustrates a typical Virtual Network Connection protocol configuration.

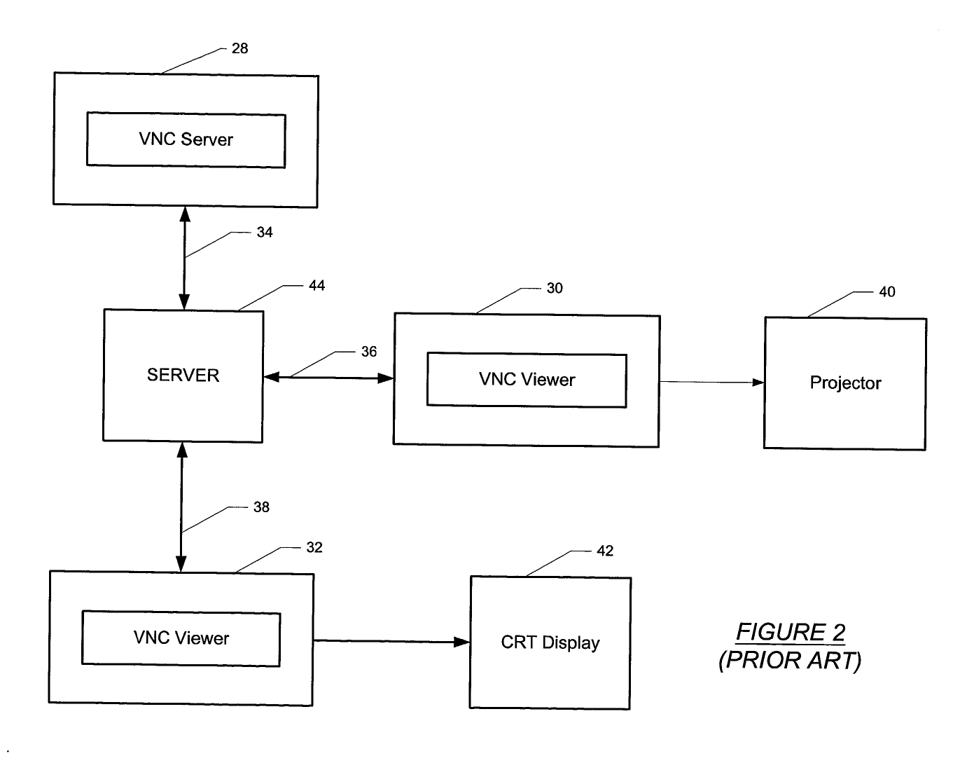

FIG. 3 illustrates a networked projection system in accordance with one embodiment of the invention.

FIG. 4 illustrates a client computer in accordance with one embodiment of the invention.

FIG. 5 illustrates a network projection controller in accordance with one embodiment of the invention.

FIG. 6 illustrates a networked projection system in accordance with one embodiment of the invention.

FIG. 7 illustrates, in flow chart form, the typical operation of a networked projection system in accordance with one embodiment of the invention.

### DETAILED DESCRIPTION

Exemplary embodiments of the invention will be described with reference to the accompanying drawings. Like items in the drawings are shown with the same reference numbers.

In the following detailed description of the invention, numerous specific details are set forth in order to provide a more thorough understanding of the invention. However, it will be apparent to one of ordinary skill in the art that the invention may be practiced without these specific details. In other instances, well-known features have not been described in detail to avoid obscuring the invention.

The present invention relates to a method for networking a projection system. The present invention further relates to a method for remotely controlling a projector across a network. The present invention further relates to a method for remotely controlling multiple projectors across multiple networks. The present invention further relates to a method for viewing multiple presentations on one projector. The present invention further relates to a network projection system performing the various methods described above.

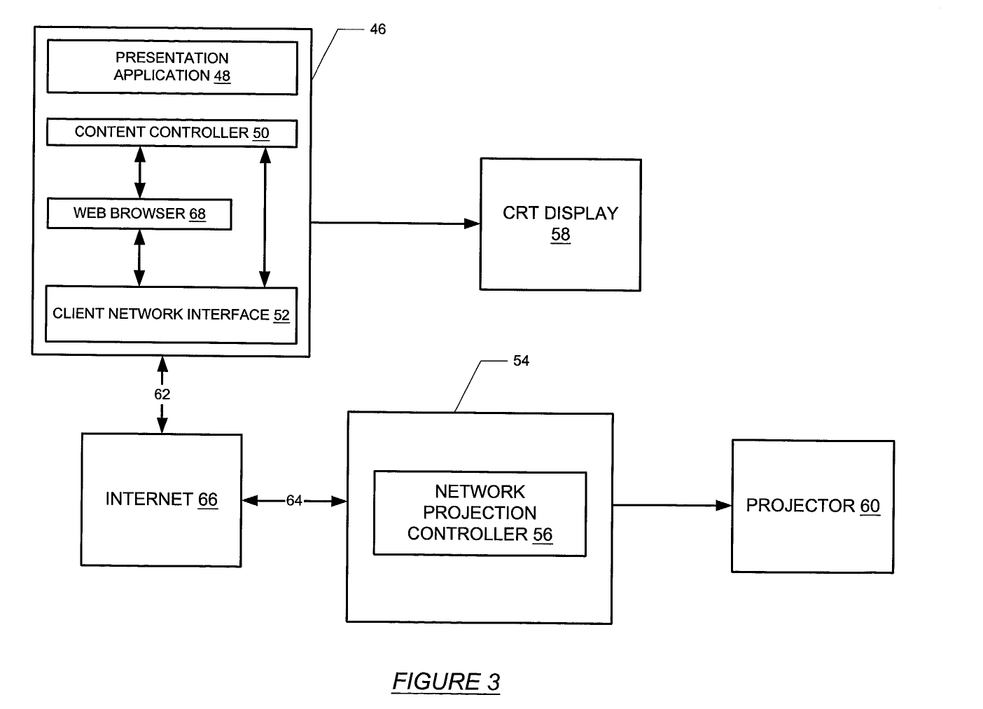

FIG. 3 illustrates an exemplary networked projection system in accordance with one embodiment of the invention. A typical network projection system includes a client computer (46) containing a presentation application (48), e.g., StarOffice™ Impress, a content controller (50), a web browser (68), a client network interface (52), and a projection computer (54) containing a network projection controller (56). Further, the client computer (46) outputs information to a CRT display (58) and the projection computer (54) outputs information to a projector (60). The client computer (46) and the projection computer (54) are connected via at least two network connections (62), (64). The network connections allow the client computer (46) and the projection computer (54) to be connected over the Internet (66). The network connections typically employ a network protocol, e.g., TCP/IP.

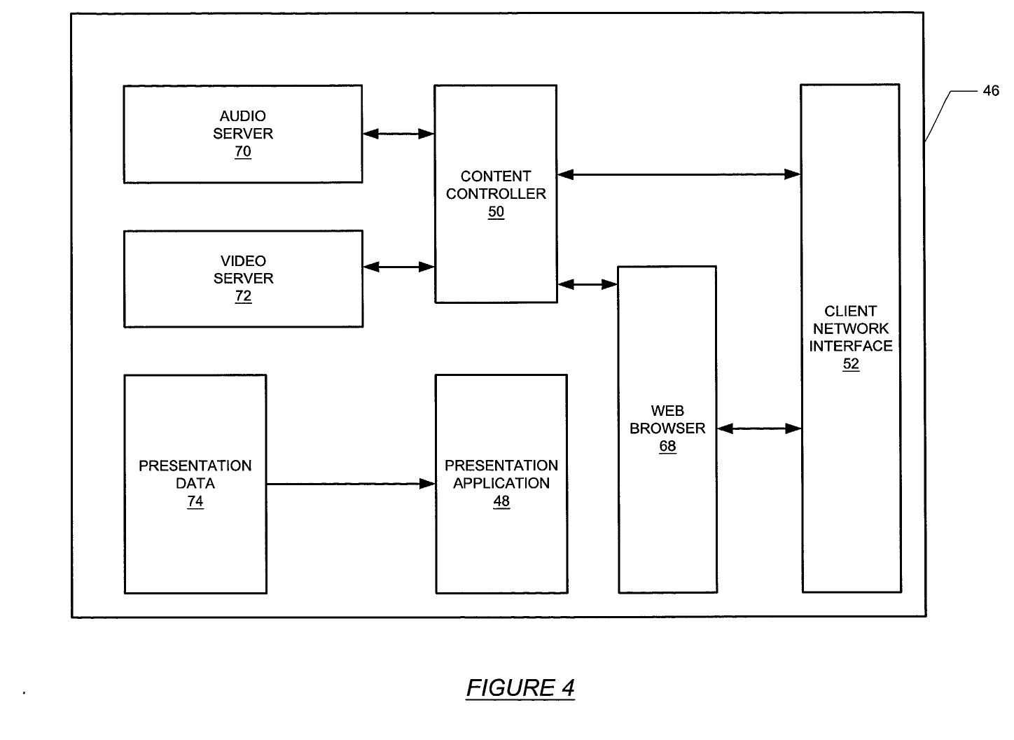

FIG. 4 illustrates an exemplary client computer in accordance with one embodiment of the invention. The client computer (46) includes a client network interface (52), a web browser (68), a content controller (50), an audio server (70), a video server (72), a presentation application (48), and presentation data (74). The client network interface (52) runs a network protocol, such as TCP/IP, to package and route data across a network. The web browser (68) is software that allows a user to view HyperText Mark-up Language documents and access files and software related to those documents. Further, the web browser (68) is also capable of such functions as downloading and transferring files, providing access to newsgroups, displaying graphics embedded in a document, playing audio and video files associated with the document, and executing small programs, e.g., Java™ applets or ActiveX® controls included by programmers in the documents. A common example of a web browser (68) is Netscape® Navigator. The content controller (50) “captures” the presentation as it is displayed on the client computer (46) and forwards the captured presentation to the projection computer (54). Typically, the content controller (50) captures the presentation by copying a screen buffer. A screen buffer is memory located on a video adapter that is used to store data that is to be shown on the display. The audio portion of the presentation may be captured by the content controller (50) using an audio buffer that is located on an audio adapter. Further, the content controller (50) interfaces with the audio server (70) and the video server (72).

In one or more embodiments of the present invention, the presentation application (48) opens the presentation data (74) and runs the presentation. When the presentation data (74) is accessed by the presentation application (48), the presentation data is converted into presentation media. Presentation media may include a combination of sound, graphics, animation, video, etc. The content controller (50) can capture all portions of the presentation media; however, the content controller (50) may only process graphics. The other portions of the presentation media, e.g., audio, video, etc., may require additional specialized components to process them. These specialized components are collectively referred to as “media servers.” Examples of two such media servers are an audio server (70) and a video server (72). The audio server (70) and the video server (72) receive the audio and video portions, respectively, of the presentation media, if present, and process the portions such that the portions may be reconstructed on the projection computer (54). Media servers may be created using a product such as Java™Media Framework.

Those skilled in the art will appreciate that while audio and video servers are described above, the present invention may contain other types of media servers. For example, the client computer may also have a time-based media server. Time-based media, also referred to in the art as “streaming media,” requires timely delivery and processing. Further, the time-based media involves delivering a steady stream of content (both audio and visual) within a particular timeframe. An example of time-based media is a QuickTime™ movie.

In one or more embodiments of the present invention, the presentation data is stored on a remote computer, which may be accessed by a client computer running the presentation application. For example, the presentation data may be stored on a file server that may be accessed by the client computer via the client network interface.

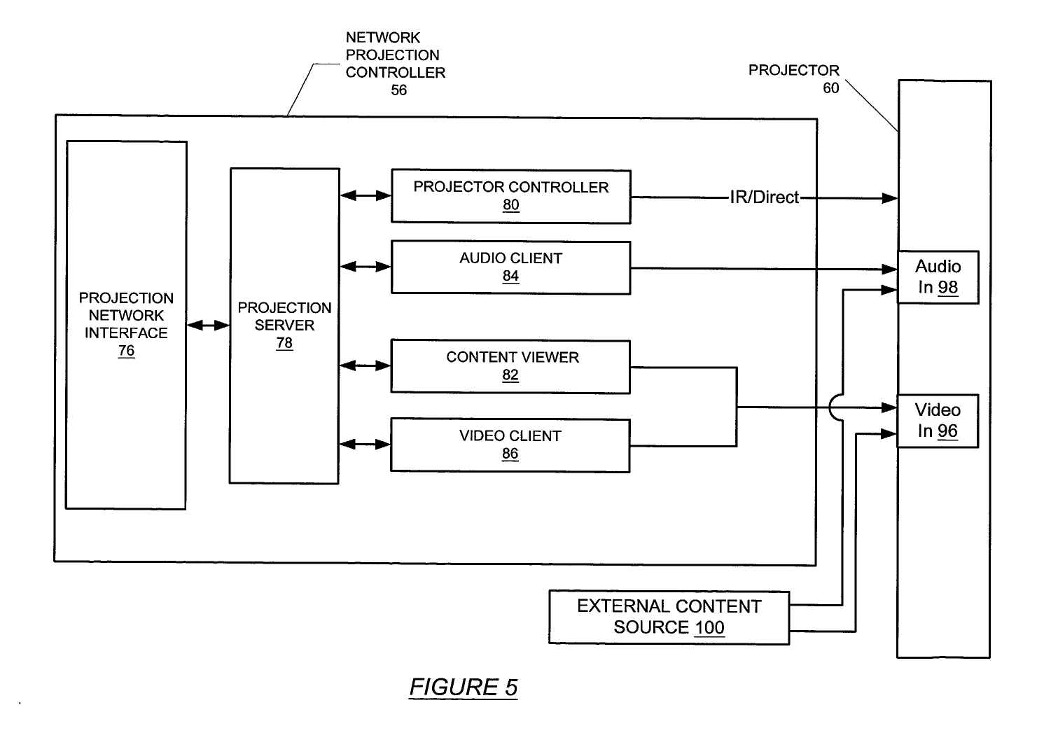

FIG. 5 illustrates a network projection controller (56) in accordance with one embodiment of the invention. The network projection controller (56) includes a projection network interface (76), a projection server (78), a projector controller (80), a content viewer (82), an audio client (84), and a video client (86). The projection network interface (76) runs a network protocol, such as TCP/IP, to package and route data across a network. The projection server (78) uses HyperText Transfer Protocol (HTTP) to serve up HTML documents and any associated files and scripts requested by a client computer running a web browser. Further, the projection server contains a configuration file that details the projector (60) configuration, setting, etc. The projector controller (80) controllers the projector functionality, such as turning the projector on or off, etc. The content viewer (82) processes the graphical non-video and non-audio portion of the presentation, e.g., slides, pictures, etc., from a client computer (not shown). The audio client (84) processes the audio portion of the presentation media sent from an audio server (not shown). Similarly, the video client (86) processes the video portion of the presentation media sent from a video server (not shown). The audio client (84) and the video client (86) may be created using a product such as Java™ Media Framework.

The projection controller (80), the content viewer (82), the audio client (84), and the video client (86) all receive data from the projection server (78). All portions of the presentation are initially received by the projection server (78) which then determines which component (e.g., content viewer (82), audio client (84), or video client (86)) is required to process each particular portion of the presentation media. Once the given component processes the particular portion of the presentation, that portion of the presentation media is forwarded to the projector (60). The visual presentation media, i.e., output from the content viewer (82), video client (86), etc., is forwarded to the video-in connection (96) on the projector (60). The audio presentation media, i.e., output from the audio client, etc., is forwarded to the audio-in connection (98) on the projector (60).

In one or more embodiments of the present invention, the network projection controller (56) is located on a separate computer that is connected to a projector (60). The network projection controller (56) may be directly connected to the projector (60) via a physical connection, such as a serial cable, or an indirect connection, such as an infrared (IR) connection.

In one or more embodiments of the present invention, an external content source (100) such as a Video Cassette Recorder (VCR), may be connected to the projector (60) via the audio-in connector (98) and the video-in connector (96). The external content source (100) may then be controlled from the client computer via the projector controller (80). For example, a video cassette may be loaded into the VCR connected to the projector (60), the user on the client computer may subsequently send a play command via the projection controller (80) which starts the VCR.

In one or more embodiments of the present invention, the network projection controller (56) is located on an embedded computer within a projector (60).

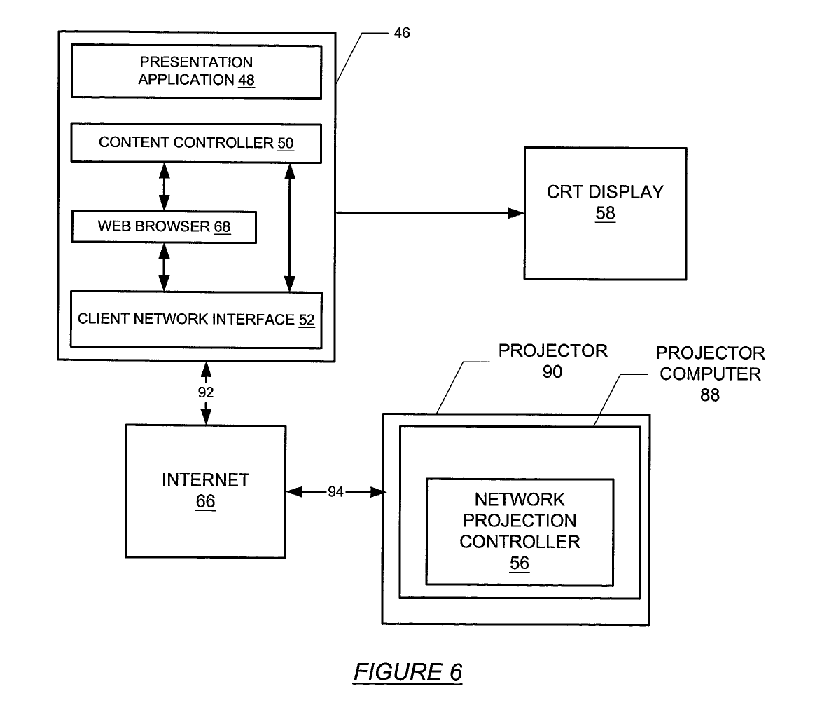

FIG. 6 illustrates an exemplary networked projection system in accordance with one embodiment of the invention. In this embodiment, a client computer (46) includes a presentation application (48), a content controller (50), a web browser (68), and a client network interface (52). The client computer (46) is connected via the Internet (66) and at least two network connections (92), (94) to a projector (90). The projector (90) includes a projection computer (88) and a network projection controller (56).

For exemplary purposes, consider a situation where a company has two campuses (campus A and campus B) located in two different cities. Once a month, the head office located at campus A requires a status report from campus B. Campus A has a networked projector running a network projection controller. Further, Campus A has a client computer containing a presentation application, a web browser, a content controller, and a client network interface. Campus B has a client computer containing a presentation application, a web browser, a content controller, and a client network interface. Additionally, Campus B also has a network projector running a network projection controller. One or more embodiments of the present invention allow the management team at Campus B to put together a presentation and then run the presentation from their offices at Campus B via the content controller and the web browser on the client computer. The client computer sends information to the network projection controller, located at campus A, where the head office management team views the presentation.

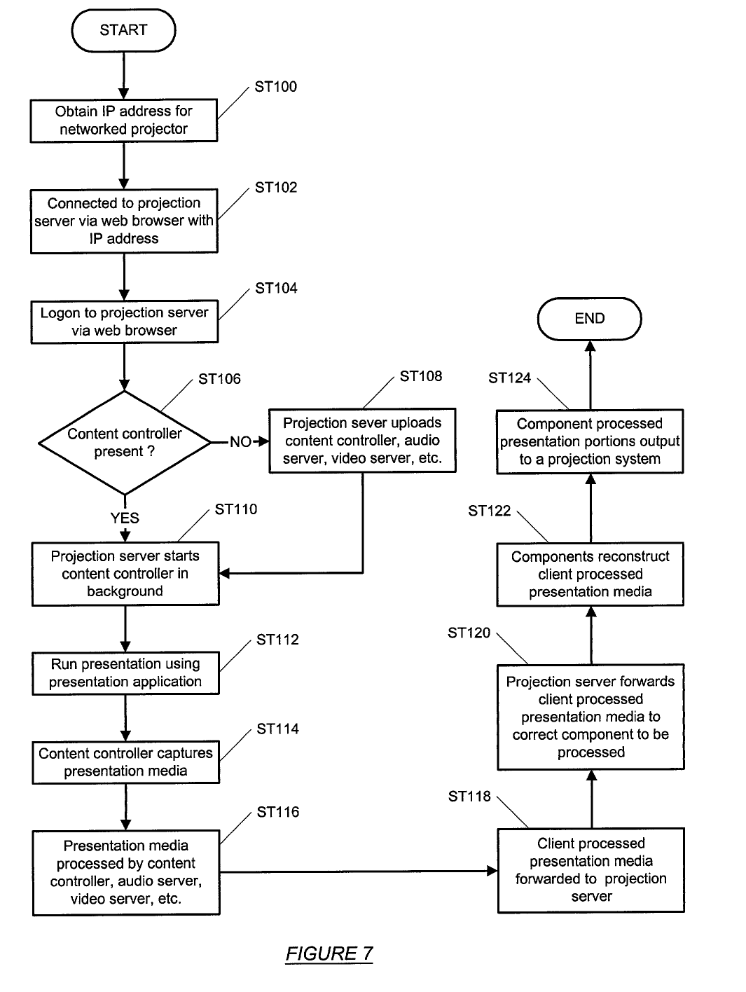

FIG. 7 illustrates, in flowchart form, the typical operation of the embodiment illustrated in FIG. 6. A user of a client computer (46) obtains an IP address for the networked projector (90) (Step 100). The IP address may be static or dynamically assigned using a service such as Dynamic Host Configuration Protocol (DHCP). The client computer (46) then connects to the projection server via a web browser (68) (Step 102). The projection server returns a logon page to the web browser (68). The user then logs on to the projection server (Step 104). The projection server may use any form of authentication, e.g., username/password, challenge/response, etc. Once the user is logged on to the projection server, the projection server determines if a content controller (50) is loaded on the client computer (46) (Step 106). If the client computer (46) does not contain the content controller (50), then the projection server uploads the content controller (50), and associated media servers, i.e., an audio server, video server, etc. (Step 108). The projection server may use a plugin such as Microsoft ActiveX® technology to upload the content controller (50) and associated media servers. If the content controller (50) is present on the client computer (46), or once the projection server completes uploading the content controller (50) and associated media servers, the projection server starts the content controller (50) in the background on the client computer (46) (Step 110). The term “background,” in the context of processes or tasks that are part of an operating system, refers to operating without interaction with the user while the user is working on another task.

The user then proceeds to run the presentation in the foreground on the client computer (46) by starting the presentation application (48) and loading the presentation data (Step 112). The term “foreground,” in the context of processes or tasks that are part of an operating system, refers to an application currently responding to commands issued by the user. The content controller (50) running in the background captures the presentation media (Step 114). The captured presentation is processed by the content controller (50), and associated media servers (Step 116). The media servers process portions of the captured presentation media that require specialized processing, such as audio, video, etc. The presentation media portions processed by the client computer (50) are forwarded via network interfaces to the projection server (Step 118).

The projection server forwards the client-processed presentation to the respective components in the networked projection system, i.e., content viewer, audio server, video server, etc. (Step 120). For example, the audio portion of the presentation is forwarded to the audio client. The components then reconstruct the presentation media such that it can be viewed on the projector, heard on the projector sound system, etc. (Step 122). The client-processed presentation content is then output to a networked projection system. The networked projection system includes a projector (90). The projection system may also include an audio system (Step 124).

In one or more embodiments of the present invention, the IP address and drivers for the networked projector are discovered using Jini™. Jini™ architecture, developed by Sun Microsystems®, allows a user to connect a network projector to a network and have other devices on the network automatically detect that the network projector is connected and available. Further, the network projector defines itself to a network device registry. When a client computer on the network attempts to access the network projector, the network projector uploads the necessary software to communicate with the device. Additionally, Jini™, being based on Java™, is platform independent, i.e., it can run on Windows® OS, Sun® OS, etc. Thus, Jini™ running on a network projector provides information, such as the IP address and the corresponding drivers, to the projection server that subsequently use the information when communicating with the network projector. This allows the projection server to be running at a different location than the network projector. For example, the projection server may be located in a server room, and the network projector may be located in a conference room. Additionally, if the projector is changed, a new network projector only needs to have Jini™ loaded to work with the network projection system, no other changes are required to be made on the projection server.

In one embodiment of the present invention, the networked projection system has one client computer and multiple networked projectors, each running a networked projection controller. Consider the scenario described above, where the company with two campuses (Campus A and Campus B) has built a third campus (Campus C) with a networked projection system having a networked projector running a network projection controller. The CEO wishes to make a presentation simultaneously to all three campuses (Campus A, Campus B, and Campus C). The present invention allows the CEO to present her presentation at all three campuses simultaneously by using a client computer at Campus A to send the presentation simultaneously to networked projectors located at Campuses A, B and C. The CEO starts three instances of the web browser. The CEO then proceeds to log on to the three separate network projectors (one at each campus). The networked projection system proceeds to start three instances of the content controller in the background. The CEO may then start the presentation application and give the presentation.

In another embodiment of the present invention, the networked projection system has multiple client computers and one networked projector. Consider the scenario described above, where the company still has three campuses (Campus A, Campus B, and Campus C). The head office, located at Campus A, still requires satellite campuses (Campus B and Campus C) to present monthly progress reports. The present invention allows client computers located at Campuses B and C to send presentations to a single networked projector located at Campus A. The client computer at Campus B and the client computer at Campus C each log on to the projection server at campus A. Once logged on to the projection server each client computer proceeds to run the presentation. The projection server at the head office, e.g., Campus A, takes presentation data from both client computers and presents the data simultaneously to the networked projection system, allowing the head office to view both presentations simultaneously. Thus, the head office could view the presentations side-by-side on their network projection system, and compare the progress of the two satellite campuses.

Those skilled in the art will appreciate that the display controller may be located on an embedded computer within a projector or on a separate computing device connected to a projector.

Advantages of the present invention may include one or more of the following. In some embodiments of the present invention, a presentation may be controlled from one location and viewed at another location. In some embodiments of the present invention, a presentation may be controlled from one location and viewed at multiple locations. In some embodiments of the present invention, the present invention operates without complex video switching equipment. In some embodiments of the present invention, multiple presentations may be viewed simultaneously, e.g., side-by-side, tiled, etc., with only one projector. The networked projector has an IP address and, therefore, may be treated in the same manner as any device attached to a network. Those skilled in the art can appreciate that the present invention may include other advantages and features.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A networked projection system having a client computer operatively connected to a projection computer, comprising:
a content controller that captures and processes presentation media located on the client computer; and
a network projection controller located on the projection computer that provides an interface between the content controller and a projector operatively connected to the projection computer.

2. The system of claim 1, further comprising:
a user interface located on the client computer for accessing and controlling the networked projection system.

3. The system of claim 1, further comprising:
a presentation application located on the client computer for executing and displaying presentation media on a display device.

4. The system of claim 1, further comprising:
a media server located on the client computer that processes and packages presentation media to send to the network projection controller.

5. The system of claim 4, wherein the media server is an audio server.

6. The system of claim 4, wherein the media server is a video server.

7. The system of claim 1, wherein the network projection controller is located on a microprocessor on the projector.

8. The system of claim 1, wherein the network projection controller comprises:
a projection server serving up Hypertext Mark-up Language documents and associated files requested by the client computer;
a projection controller operatively connected to the projection server controlling projector functionality; and
a content viewer operatively connected to the projection server for reconstructing captured presentation media.

9. The system of claim 8, further comprising:
a media client configured to reconstruct specific portions of the presentation media.

10. The system of claim 9, wherein the media client is an audio client.

11. The system of claim 9, wherein the media client is a video client.

12. A networked projection system having a client computer operatively connected to a projection computer, comprising:
a content controller that captures and processes presentation media located on the client computer;
a network projection controller located on the projection computer that provides an interface between the content controller and a projector operatively connected to the projection computer;
a user interface located on the client computer for accessing and controlling the networked projection system;
a presentation application located on the client computer for executing and displaying presentation media on a display device; and
a media server located on the client computer that processes and packages presentation media to send to the network projection controller.

13. A method for using a networked projection system, comprising:
connecting to a projection server from a client computer;
accessing the projection server from the client computer;
determining if a content controller is located on the client computer by the projection server;
loading the content controller and media servers if the content controller is not located on the client computer;
initializing the content controller on the client computer by the projection server;
executing a presentation using a presentation application on the client computer;
capturing presentation media by the content controller;
processing presentation media on the client computer by the content controller;
forwarding processed presentation media from the client computer to the projection server;
reconstructing presentation media by a media viewer operatively connected to the projection server; and
outputting reconstructed presentation media to a projector.

14. The method of claim 13, wherein the client computer uses Transport Connection Protocol/Internet Protocol to connect to the projection server.

15. The method of claim 13, wherein the content controller and the media server are loaded using a plugin technology.

16. The method of claim 13, wherein the content controller executed as a background process on the client computer.

17. The method of claim 13, wherein the presentation application executed as a foreground process on the client computer.

18. The method of claim 13, wherein the presentation media captured by the content controller is processed using a media server.

19. The method of claim 18, wherein the media server is an audio server.

20. The method of claim 18, wherein the media server is a video server.

21. The method of claim 13, wherein the media viewer is a content viewer.

22. The method of claim 13, wherein the media viewer is a media client.

23. The method of claim 22, wherein the media client is an audio client.

24. The method of claim 22, wherein the media client is a video client.

25. The method of claim 13, wherein presentation media is output to the projector system via an Infrared connection.

26. The method of claim 13, wherein presentation media is output to the projector system via a direct serial connection.

27. An apparatus for using a networked projection system, comprising:
means for connecting to a projection server from a client computer;
means for accessing the projection server from the client computer;
means for determining if a content controller is located on the client computer by the projection server;
means for loading the content controller and media servers if the content controller is not located on the client computer;
means for initializing the content controller on the client computer by the projection server;
means for executing a presentation using a presentation application on the client computer;
means for capturing presentation media by the content controller;
means for processing presentation media on the client computer by the content controller;
means for forwarding processed presentation media from the client computer to the projection server;
means for reconstructing presentation media by a media viewer operatively connected to the projection server; and
means for outputting reconstructed presentation media to a projector.
